(19) United States
(12) Patent Application Publication
(10) Pub. No.: US 2002/0194929 A1
(43) Pub. Date: Dec. 26, 2002

(54) Method for determining compressive strength of cores

(76) Inventors: Ruijie Liu, Austin, TX (US); Maoxin Li, Tianjin (CN)

Correspondence Address: RUIJIE LIU, 8312 Fathom Circle, # 112, Austin, TX, 78750, US

(21) Appl. No.: 09/886,697

(22) Filed: Jun. 22, 2001

(51) Int. Cl. G01N 3/08

(52) U.S. Cl. 73/818

(57) ABSTRACT

This invention is a method for determining the compressive strength of cores obtained from concrete or similar materials by applying the load on 4 lines on the core cylindrical surface through a specially designed but very simple apparatus. The four loading lines are uniformly distributed on the circumstance of the test section of the core through using the apparatus so that the core is compressed in two diametrical directions—dual-dual directions orthogonal to each other. The stresses in the test section of cores are in three dimensional compression state and thus the test is of compressive nature. This invention avoids the trimming, capping, and curing operations which the conventional core test has to follow. Moreover, some factors that may result in the reduction in the reliability and the practical benefit of the core test can be greatly restrained or removed.

### BACKGROUND OF THE INVENTION

The concrete industry has been seeking some effective and reliable techniques to determine in situ concrete strength. The accurate determination on the compressive strength of concrete structures often becomes the key for accident analysis or lawsuit when structural failure or damage happens. The core test is the most reliable and direct method to determine in situ concrete strength of structures. The conventional core test is always performed according to a standard code such as ASTM C42-90, “Standard Test Method for Obtaining and Testing Drilled Cores and Sawed Beams of Concrete” (American Society for Testing and Materials, Philadelphia, 1990). Cores are first drilled out from the structures, then trimmed, capped or grinned, and cured. Trimming a core induces a frustration noise that is extremely harmful to the operator and the environment. Capping needs special materials and mix designs to guarantee that the two capped ends of the core have enough strength to resist any damage before the failure happens inside the core. Trimming and Capping must make the core ends plain and normal to the core axis, which must be carefully performed using special and expensive machines. Curing operation is simple, but the test has to be scheduled to wait until the capped materials develop very well. These processing operations result in a noise frustration, time-consuming, and expensive core testing.

The present state of the art has a few artful schemes to avoid the trimming, capping, and curing operations for core testing. They are the tip bending test invented by Johansen in “Method for In Situ Determination of Concrete Strength,” U.S. Pat. No. 4,044,608, Aug. 30, 1977; the point-load test given in “The Point-Load Strength Tests for Cores” by Robins, Magazine of Concrete Research, Vol. 32, No. 111, June 1980, pp. 101-111; the gas pressure tension test found in “Fluid Pressure Testing of Concrete Cylinders” by Clayton, Magazine of Concrete Research, Vol. 30, No. 102, March 1978, pp. 26-30; and the diameter-compression test found in “The Diameter-Compression Test for Small Diameter Cores” by Liu, Materials and Structures, Vol. 29, January-February 1996, pp. 56-59.

The tip bending test is to directly apply load on the top end of the core that is not removed from the structure. The rupture occurs at the base of the core projection and the flexural strength of the test section is computed. In the point-load test a compressive load is applied across the diameter by means of a portable hydraulic jack. This test is essentially a tensile test and the tensile strength is evaluated. In the gas pressure tension test, a core is inserted into a cylindrical steel jacket with seals at each end, and gas pressure is applied to the bare curved surface to make concrete failure by tension. All three methods are rapid and cheap but none of them are adequate for assessing the compressive strength of cores because of the tensile nature of these tests and no reliable relationship between the tensile and compressive strengths.

The diameter-compression test uses a couple of metal semicircles to apply a compressive load on the cylindrical surface and along a short length in the axis direction. The materials compressed between the two metal blocks are in a three dimensional compression state. Therefore, this test is a compressive test and works for determining the compressive strength of materials. As the loading is applied on the cylindrical surface with an extended area, the core surface must be very smooth in order to get a reliable result. The error in core diameter must also be very small. Otherwise, a large fluctuation in core diameter will change the stress states of the compressed cores and finally result in the higher variation of test and the reduction of the test accuracy. It is extremely difficult, however, to obtain cores with very smooth surface and little fluctuation in diameter especially from the fields. In addition, a compression test machine with much higher loading capacity is required for this test.

### SUMMARY OF THE INVENTION

The objective of this invention is to provide a noiseless, rapid, cheap, and reliable testing method of assessing the compressive strength of cores. In the invention the core is loaded on its cylindrical surface through four lines using a specially designed loading system—a couple of metal blocks. The four loading lines are on the cylindrical surface, uniformly distributed on the circumstance of the cross-section of the core, and parallel to each other and the core axis. The core is compressed in two diametrical directions—dual-dual directions orthogonal to each other.

Compared with the conventional core test, this invention avoids core cutting, capping, and curing operations because of the cylindrical surface loading scheme and thus leads to a noiseless and timesaving test.

Compared with the tip bending test, the point-load test, and the gas pressure tension test, this invention is essentially a compression test other than a tensile test. At the core center of the test segment the materials are in a three-dimensional and poorly distributed compressive state. This invention guarantees that the test is of compressive nature and thus of higher reliability than the methods with a tensile nature in assessing the compressive strength of cores.

Compared with the diameter-compression test, this invention is also to apply a compressive load on the cylindrical surfaces of cores. The difference is in that the load is only applied at four lines on the surface in this invention other than on a mount of area. The line or dual-dual loading is quite insensitive to the cylindrical surface condition. Therefore, the completely smooth surfaces of cores are not strictly required for this invention any more. Moreover, the error in core diameter does not make any change in the configuration of the stress states of the cores. Only one set of loading system is enough for all cores even with much larger diameter fluctuation at the required nominal diameter. This means that the strict drilling process leading to sound cores with little diameter fluctuation required for the diameter-compression test will not be required any more. In addition, because of much less area loaded on the core, the machine compression capacity required in this invention test is much less than that required by the diameter-compression test. This invention permits the use of small portable equipment on site at a reduced unit cost.

Finally but most importantly, the coefficient of the test variation of this invention is much lower than that of the conventional core test and other methods mentioned in this paper. Therefore, higher reliability or accuracy of core test may be achieved using this invention.

### BRIEF DESCRIPTION OF THE DRAWINGS

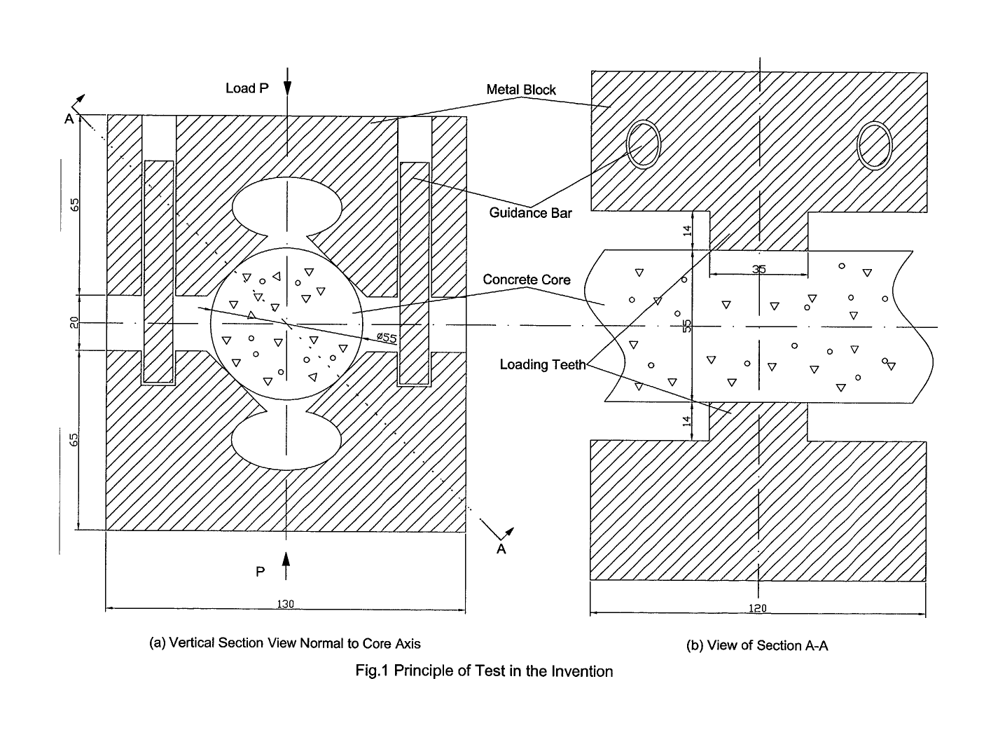

An embodiment of the invention will now be described by way of example with reference to the accompany drawing, in which FIG. 1 illustrates the principle of the test of the invention by a loading system example. FIG. 1a is a view of vertical section perpendicular to the core axis and through the two metal blocks and the tested core. FIG. 1b gives another section view marked by A-A in FIG. 1a so that the configuration of the loading teeth is clear. All unite in the drawing is in millimeter.

### DETAILED DESCRIPTION OF THE INVENTION

FIG. 1 shows the configuration of a loading system using the invention method. The shown loading system consists of the upper metal block, the lower metal block, and the guidance bars. This loading system will be put between the upper and lower compression plates of a test machine. Each metal block in the said loading system has an 90 degree open notch that consists of two identical loading teeth shown in FIG. 1b. The said two loading teeth are on the same plane and perpendicular to each other. The function of these loading teeth is to transfer the force provided by the test machine from the two metal blocks to the core body through the particular line contact on the cylindrical surface of the core. The four loading lines are uniformly distributed on the circumstance of the test section of the core. Multiple dual cylindrical holes are perforated in the two metal blocks. These holes are used to hold the guidance bars. The holes in the upper metal block are completely opened. The use of the holes and bars makes the total four loading teeth be in the same plane in a convenient way when the core is arranged to the inside of the metal blocks. In addition, the guidance bars only allow the two metal blocks move freely in the vertical direction. The punched space with a curved surface at the center of each metal block is designed to avoid a sharp angle over there in order to reduce the stress concentration at the middle part of the metal block.

FIG. 1 is the illustrated example especially for testing concrete cores of diameter φ55 mm. The main parameters in the drawing are:

(1) Tooth: 14 mm complete height and 35 mm width.

(2) Metal Block: 65 mm height, 130 mm width, 120 mm length, and steel materials.

(3) Clear distance between the upper and lower steel blocks after a core is set up is 20 mm.

These parameters are appropriate for testing concrete cores with 55 mm diameter and with 10˜50 Mpa strength grades.

It should be emphasized, however, that no principle requirements in the invention on the holes, the punched curved space, the bars, the sizes of the metal block, and the sizes of the loading teeth are regulated as described in above. The only requirements by the invention are:

(1) The body of the metal block is large and strong enough to avoid any obvious deformation when loading.

(2) The four loading teeth are identical and must be applied in the same plane in testing. The loading system must be designed to make the four loading lines uniformly distributed on the test section of the core.

(3) The loading teeth should be straight, flat, and high enough to allow any possibly large deformation of the core and avoid any contact between the tooth bed and the test materials before the core fails. The ratio of the width of each loading tooth to the diameter of the cores is between ⅓ and 1.0.

(4) The clear distance between the upper and lower blocks is large enough to avoid any contact between the upper and lower metal blocks before the test core fails.

A user of this invention may design his or her own loading system by following these four requirements.

To determine the compressive strength of materials using this invention, the relationship between the test index P (KN) of cores and the strength ƒₛₛ (Mpa) of standard cube or cylinder specimens

ƒₛₛ=ƒ(p) (1)

should be established through the experiments prior to a practical testing because Eq. (1) is depending on the materials, diameters of cores, and compressed lengths along the axial direction of core.

For concrete and mortar materials with strength grades below 50 Mpa a simple linear relationship between ƒₛₛ and p was found and established through the tests of cores of diameter 55 mm and standard cubes of length of 150 mm. It is:

ƒₛₛ=1.08 p (2)

where ƒₛₛ is the strength of standard cubes in MPa, p is the test index in KN. The compressed length (the width of the loading teeth) of cores is 35 mm. The coefficient of correlation of Eq.(2) is up to 0.98. The typical coefficients of the test variation of the invention method for cement mortar and concrete are 7% and 15%, respectively.

We claim:

1. A method for determining the compressive strength of cores by using a pair of metal blocks to apply load on the cylindrical surface of cores through four contact lines uniformly distributed on the circumstance of the cross section of cores and thus to make the core compressed in the dual-dual diametrical directions orthogonal to each other.

2. A method according to claim 1 where each said metal block is composed of a 90 degree open notch adaptive to the core size and a pair of identical loading teeth perpendicular to each other.

3. A method according to claim 2, in which each said loading tooth has a straight and plain head.
